(19) United States
(12) Patent Application Publication
(10) Pub. No.: US 2016/0260573 A1
(43) Pub. Date: Sep. 8, 2016

(54) X-RAY TUBE HAVING NON-EVAPORABLE GETTER

(71) Applicant: Rae Jun Park, Wonju (KR)

(72) Inventor: Rae Jun Park, Wonju (KR)

(73) Assignee: XL CO., LTD., Wonju (KR)

(21) Appl. No.: 15/158,545

(22) Filed: May 18, 2016

Related U.S. Application Data
(63) Continuation of application No. 13/530,568, filed on Jun. 22, 2012, now abandoned.
Application No. 13/530,568 is a continuation of application No. PCT/KR2010/004174, filed on Jun. 28, 2010.

(30) Foreign Application Priority Data
Mar. 26, 2010 (KR) 10-2010-0027522

(51) Int. Cl. H01J 35/20; H01J 35/18; H01J 35/10; H01J 35/14

(52) U.S. Cl. CPC H01J 35/20; H01J 35/14; H01J 35/18; H01J 35/10; H01J 2235/205

(57) ABSTRACT

The present invention relates to an X-ray tube with non-evaporable getters disposed therein for maintaining a degree of vacuum sufficient to operate the X-ray tube. The present invention provides a fixed-anode X-ray tube and a rotating-anode X-ray tube in which non-evaporable getters are disposed. The X-ray tubes, even when rated power is introduced without an aging process, can perform gas adsorption sufficiently and stably during operation, despite gases that can be generated by the filament and the cathode focusing cap and gases that can be generated by the target.

### CROSS-REFERENCE TO RELATED APPLICATION

This is a continuation of U.S. application Ser. No. 13/530,568 filed on Jun. 22, 2012 which is a continuation of PCT/KR2010/004174 filed on Jun. 28, 2010, which claims priority to Korean Application No. 10-2010-0027522 filed on Mar. 26, 2010, which applications are incorporated by reference herein.

### TECHNICAL FIELD

The present disclosure relates to an X-ray tube in which non-evaporable getters are disposed, more particularly, a fixed-anode X-ray tube and a rotating-anode X-ray tube in which non-evaporable getters are disposed to a focusing cap of the anode and cathode thereof.

### BACKGROUND ART

In a typical vacuum discharge system, a vacuum pump is connected to a vessel and optionally, an ancillary pump sequentially connected to the vacuum pump is used. The vessel and discharge lines are made of aluminum, stainless steel, quartz, or pyrex. In case of a vacuum discharge system suitable to provide a low or medium degree of vacuum (about 10⁻³ Torr), a rotary pump connected in series to a booster pump is connected to a chamber or a rotary pump alone is connected to a chamber. In case of a vacuum discharge system suitable for providing a high degree of vacuum (about 10⁻⁴˜10⁻⁷ Torr), an oil pump or turbomolecular pump attached to a liquid nitrogen cooling trap is used and such a pump is connected in series to a rotary pump as an ancillary pump. A vacuum discharge system to be used to vacuum discharge an X-ray tube is required to provide a very high degree of vacuum (about 10⁻⁸˜10⁻¹¹Torr).

Typically, a vacuum discharge of an X-ray tube is performed before sealing and after sealing. In prior-sealing vacuum discharge, a vacuum discharge system to provide a very high degree of vacuum using a cryo pump or ion pump is used. Even a small amount of oxygen or moisture can significantly affect the quality/degree of vacuum. The physical adsorption time of moisture is in the range of ms, which is much longer that that of inert gases and gas particles (e.g., hydrogen particles). Accordingly, moisture can remain in a vacuum space of a vacuum vessel for a longer time and show various adsorption states, thereby lowering the quality/degree of vacuum. To discharge moisture of a vacuum space within a shorter time, the vacuum vessel can be heated so as to decrease the adsorption time of moisture. Generally, the vessel is heated at 150° C. to desorb moisture. The temperature can be changed according to required specification of the vacuum system and targeted degree of vacuum. The vacuum discharge of an X-ray tube is performed, typically, in the following order: (a) low or middle level vacuum discharging, (b) high level vacuum discharging, (c) vacuum discharging with a vacuum vessel and discharge lines being heating, (d) degasifying various heat-generating elements (e.g., vacuum gauge) provided inside the vacuum vessel before the heated vacuum vessel is cooled, and (e) base vacuum discharging.

In post-sealing vacuum discharge, getters are provided to adsorb remaining gases inside an X-ray tube. Evaporable getters or non-evaporable getters are used. Examples of materials of evaporable getters are Ba, an alloy of Ba—Al—Ni, Ca (U.S. Pat. No. 6,583,559), alkalie metals (U.S. Pat. No. 4,665,343), and the like. Evaporable getters are coated on a small area in a back surface of a cathode such that they are not electrically connected to electrical lines of the cathode and the coated getters function to adsorb remaining gases. Examplary materials for non-evaporable getters are Zr, Ti, Ni, or an alloy based on these metals. Powders are subjected to a sintering process or a pressing process to form a porous structure.

Various X-ray tubes with getters have been proposed. For example, an X-ray tube including a vacuum housing in which an anode and a cathode are disposed, a first getter that can perform adsorption by heat radiation radiated from the anode when the anode is at a high temperature is disposed at a location neighboring the anode, and a second getter that can perform adsorption by high temperature heat radiation is disposed at the cathode was proposed, as described in, e.g., U.S. Pat. No. 005,838,761.

An X-ray tube including a metal housing in which an evaporable gettering system is provided near the cathode such that evaporable getters are provided as a layer on grounded portion of the metal housing to thereby increase gas adsorption rate and the getters can be reactivated multiple times in the field was proposed, as described in, e.g., U.S. Pat. No. 6,570,959B1.

An X-ray tube with evaporable getters disposed at an upper part of a cathode in which the getters can be repeatedly evaporated in a limited region of a housing neighboring the upper part of the cathode by selectively providing electric power from an external side of the X-ray tube was proposed, as described in, e.g., U.S. Pat. No. 6,192,106A1 and U.S. Pat. No. 06,192,106B1.

An X-ray tube including an evacuated envelope in which an anode, a cathode, and a getter shield are disposed was proposed, as described in, e.g., U.S. Pat. No. 05,509,045. The shield includes a cap defining an annular groove. A getter material is deposited in the groove and sintered to define a porous volume. During operation of the X-ray tube to generate X-rays, the cap is heated by heat generated from the anode to thereby reactivate the getterring material so as to adsorb gases.

X-ray tubes having a high level of vacuum state using the above-described methods, however, have a problem that gases remaining at sealing, gases introduced in degasification, gases generated in heating filaments, and gases generated at a target during operation cause inner pressure to be increased, which can affect operation performance and lose main function of the X-ray tubes.

Because of the increased amount of gases, getters disposed in sealed X-ray tubes may not adsorb completely. Typically, the inner gas pressure is sharply increased at an early stage in which X-rays start to be generated. The sharp increase can cause the X-ray tubes to be discharged and lose its main function. To prevent this problem, a low level of power is introduced before rated power is introduced to thereby reduce gas generation and an aging process is performed to delay the gas pressure increase.

### SUMMARY OF THE DISCLOSURE

An object of the invention is to provide an X-ray tube having non-evaporable getters disposed therein, thereby being able to prevent the inner pressure of the X-ray tube from being increased by gas adsorption by non-evaporable getters activated due to heat radiated by the anode when the anode is heated during operation of the X-ray tube.

Another object of the invention is to provide an X-ray tube having non-evaporable getters disposed therein, thereby being able to prevent the inner pressure of the X-ray tube from being increased by gas adsorption by non-evaporable getters activated due to thermal conduction caused when the anode is heated during operation of the X-ray tube.

Still another object of the invention is to provide an X-ray tube which can a high degree of vacuum sufficient to operate the X-ray tube even then rated power is introduced without an aging process.

In some embodiments, the present invention provides an X-ray tube comprising: an outer bulb; a cathode focusing cap fixedly mounted inside the outer bulb and provided with a filament; an anode an end of which is mounted inside the outer bulb and the other end of which is protruding from the outer bulb so as to be outside the outer bulb, the anode being provided with a target to which electron beam generated by the filament is to be collided; and an anode shielding unit provided near the anode, the anode shielding unit being provided with a radiation window that can shield the target and irradiate X-rays generated by the target, wherein the anode shielding unit is provided with non-evaporable getters for gas adsorption. The anode shielding unit may be provided with non-evaporable getters for gas adsorption by providing a gettering structure in the form of a band or cylinder, the structure having gettering materials disposed on one or both sides thereof as a porous structure, and mounting the gettering structure to an inner circumferential surface or an outer circumferential surface of the anode shielding unit. Alternatively, the anode shielding unit may be provided with non-evaporable getters for gas adsorption by disposing gettering materials on an inner circumferential surface or an outer circumferential surface of the anode shielding unit. Gettering materials can be disposed in a single layer or multiple layers.

In some embodiments, the present invention provides an X-ray tube comprising: an outer bulb; a cathode focusing cap fixedly mounted inside the outer bulb and provided with a filament; an anode an end of which is mounted inside the outer bulb and the other end of which is protruding from the outer bulb so as to be outside the outer bulb, the anode being provided with a target to which electron beam generated by the filament is to be collided; and an anode shielding unit provided near the anode, the anode shielding unit being provided with a radiation window that can shield the target and irradiate X-rays generated by the target, wherein the cathode focusing cap is provided with non-evaporable getters for gas adsorption. In some embodiments, the present invention provides an X-ray tube comprising: an outer bulb; a cathode focusing cap fixedly mounted inside the outer bulb and provided with a filament; and an anode an end of which is mounted inside the outer bulb and the other end of which is protruding from the outer bulb so as to be outside the outer bulb, the anode being provided with a target to which electron beam generated by the filament is to be collided, wherein the cathode focusing cap is provided with non-evaporable getters for gas adsorption. In some embodiments, the present invention provides an X-ray tube comprising: an outer bulb; an electrode stem unit fixedly mounted inside the outer bulb; a cathode focusing cap fixedly mounted to the electrode stem unit and provided with a filament; a rotating-anode target to which electron beam generated by the filament is to be collided; and a rotor for rotating the rotating-anode target, wherein the cathode focusing cap is provided with non-evaporable getters for gas adsorption. In these embodiments, the cathode focusing cap may be provided with non-evaporable getters for gas adsorption by providing a gettering structure corresponding to the outer shape of the cathode focusing cap, the structure having gettering materials disposed on one or both sides thereof as a porous structure, and mounting the gettering structure to an inner circumferential surface or an outer circumferential surface of the anode shielding unit. Alternatively, the cathode focusing cap may be provided with non-evaporable getters for gas adsorption by disposing gettering materials on an outer circumferential surface of the cathode focusing cap. Gettering materials can be disposed in a single layer or multiple layers.

In some embodiments, the present invention provides an X-ray tube comprising: an outer bulb; a cathode focusing cap fixedly mounted inside the outer bulb and provided with a filament; an anode an end of which is mounted inside the outer bulb and the other end of which is protruding from the outer bulb so as to be outside the outer bulb, the anode being provided with a target to which electron beam generated by the filament is to be collided; and a metal cylinder mounted inside the outer bulb to surround the anode, the metal cylinder being provided with a radiation window, wherein the metal cylinder is provided with non-evaporable getters for gas adsorption.

In some embodiments, the present invention provides an X-ray tube comprising: an outer bulb; an electrode stem unit fixedly mounted inside the outer bulb; a cathode focusing cap fixedly mounted to the electrode stem unit and provided with a filament; a rotating-anode target to which electron beam generated by the filament is to be collided; a rotor for rotating the rotating-anode target; and a metal cylinder mounted inside the outer bulb to surround the rotating-anode target, the metal cylinder being provided with a radiation window, wherein the metal cylinder is provided with non-evaporable getters for gas adsorption. In these embodiments, the metal cylinder may be provided with non-evaporable getters for gas adsorption by disposing gettering materials on an inner surface or an outer surface of the metal cylinder. Alternatively, the metal cylinder may be provided with non-evaporable getters for gas adsorption by providing a gettering structure in the form of a band or cylinder, the structure having gettering materials disposed on one or both sides thereof as a porous structure, and mounting the gettering structure to an inner circumferential surface or an outer circumferential surface of the metal cylinder. Gettering materials can be disposed in a single layer or multiple layers.

In some embodiments, the present invention provides an X-ray tube comprising: an outer bulb; a cathode focusing cap fixedly mounted inside the outer bulb and provided with a filament; and an anode an end of which is mounted inside the outer bulb and the other end of which is protruding from the outer bulb so as to be outside the outer bulb, the anode being provided with a target to which electron beam generated by the filament is to be collided, wherein an outer circumferential surface of the anode inside the outer bulb is provided with non-evaporable getters for gas adsorption. In these embodiments, the outer circumferential surface of the anode inside the outer bulb may be provided with non-evaporable getters for gas adsorption by disposing gettering materials on the outer circumferential surface of the anode. Alternatively, the outer circumferential surface of the anode inside the outer bulb may be provided with non-evaporable getters for gas adsorption by providing a gettering structure in the form of a band or cylinder, the structure having gettering materials disposed on one or both sides thereof as a porous structure, and mounting the gettering structure to the outer circumferential surface of the anode. Gettering materials can be disposed in a single layer or multiple layers.

In some embodiments, the present invention provides an X-ray tube comprising: an outer bulb; an electrode stem unit fixedly mounted inside the outer bulb; a cathode focusing cap fixedly mounted to the electrode stem unit and provided with a filament; a rotating-anode target to which electron beam generated by the filament is to be collided; and a rotor for rotating the rotating-anode target, wherein the rotating-anode target is provided with non-evaporable getters for gas adsorption. In these embodiments, The rotating-anode target may be provided with non-evaporable getters for gas adsorption by disposing gettering materials on a back surface of the rotating-anode target. Alternatively, the rotating-anode target may be provided with non-evaporable getters for gas adsorption by providing a gettering structure in the form of a circular plate, the structure having gettering materials disposed on one or both sides thereof as a porous structure, and mounting the gettering structure to a back surface of the rotating-anode target. Gettering materials can be disposed in a single layer or multiple layers.

In some embodiments, the present invention provides an X-ray tube comprising: an outer bulb; an electrode stem unit fixedly mounted inside the outer bulb; a cathode focusing cap fixedly mounted to the electrode stem unit and provided with a filament; a rotating-anode target to which electron beam generated by the filament is to be collided; and a rotor for rotating the rotating-anode target, wherein the rotor is provided with non-evaporable getters for gas adsorption. In these embodiments, the rotor may be provided with non-evaporable getters for gas adsorption by disposing gettering materials on an outer circumferential surface of the rotor. Alternatively, the rotor may be provided with non-evaporable getters for gas adsorption by providing a gettering structure in the form of a band or cylinder, the structure having gettering materials disposed on one or both sides thereof as a porous structure, and mounting the gettering structure to an outer circumferential surface of the rotor. Gettering materials can be disposed in a single layer or multiple layers.

The X-ray tubes with non-evaporable getters disposed therein according to the embodiments of the present invention have sufficient gas adsorption during operation to prevent gas pressure of the X-ray tubes from being increased even when rated power is introduced without an aging process, thereby enabling the X-ray tubes to provide stably a high degree of vacuum necessary for operation of the X-ray tubes.

In addition, the X-ray tubes according to the embodiments of the present invention can maintain a high degree of vacuum stably during operation even when rated power is introduced without an aging process, thereby being industrially or medically applicable.

### BRIEF DESCRIPTION OF THE DRAWINGS

FIG. 1 is a cross-sectional view of a shielded fixed-anode X-ray tube.

FIG. 2 is a cross-sectional view of the anode of a shielded fixed-anode X-ray tube.

FIG. 3 is a cross-sectional view of an exposed fixed-anode X-ray tube.

FIG. 4 are a perspective view and a partially cross-sectional view of a metal cylinder for disposition of non-evaporable getters in an exposed fixed-anode X-ray tube.

FIG. 5 is a cross-sectional view of a rotating-anode X-ray tube.

FIG. 6 is a cross-sectional view of a metal cylinder for disposition of non-evaporable getters in a rotating-anode X-ray tube.

FIG. 7 is a cross-sectional view of non-evaporable getters disposed in a cathode focusing cap.

FIG. 8 is a cross-sectional view of non-evaporable getters disposed in an anode of a fixed-anode X-ray tube.

FIG. 9 is a cross-sectional view of non-evaporable getters disposed in an anode of a rotating-anode X-ray tube.

### DETAILED DESCRIPTION OF THE DISCLOSURE

A first embodiment of the invention provides an X-ray tube comprising: an outer bulb; a cathode focusing cap fixedly mounted inside the outer bulb and provided with a filament; an anode an end of which is mounted inside the outer bulb and the other end of which is protruding from the outer bulb so as to be outside the outer bulb, the anode being provided with a target to which electron beam generated by the filament is to be collided; and an anode shielding unit provided near the anode, the anode shielding unit being provided with a radiation window that can shield the target and irradiate X-rays generated by the target, wherein the anode shielding unit is provided with non-evaporable getters for gas adsorption.

A second embodiment of the present invention provides an X-ray tube comprising: an outer bulb; a cathode focusing cap fixedly mounted inside the outer bulb and provided with a filament; an anode an end of which is mounted inside the outer bulb and the other end of which is protruding from the outer bulb so as to be outside the outer bulb, the anode being provided with a target to which electron beam generated by the filament is to be collided; and a metal cylinder mounted inside the outer bulb to surround the anode, the metal cylinder being provided with a radiation window, wherein the metal cylinder is provided with non-evaporable getters for gas adsorption.

A third embodiment of the present invention provides an X-ray tube comprising: an outer bulb; an electrode stem unit fixedly mounted inside the outer bulb; a cathode focusing cap fixedly mounted to the electrode stem unit and provided with a filament; a rotating-anode target to which electron beam generated by the filament is to be collided; a rotor for rotating the rotating-anode target; a metal cylinder mounted inside the outer bulb to surround the rotating-anode target, the metal cylinder being provided with a radiation window, wherein the metal cylinder is provided with non-evaporable getters for gas adsorption.

Hereinafter reference will now be made in detail to various embodiments of the present invention, examples of which are illustrated in the accompanying drawings and described below. While the invention will be described in conjunction with exemplary embodiments, it will be understood that present description is not intended to limit the scope of the invention to those exemplary embodiments.

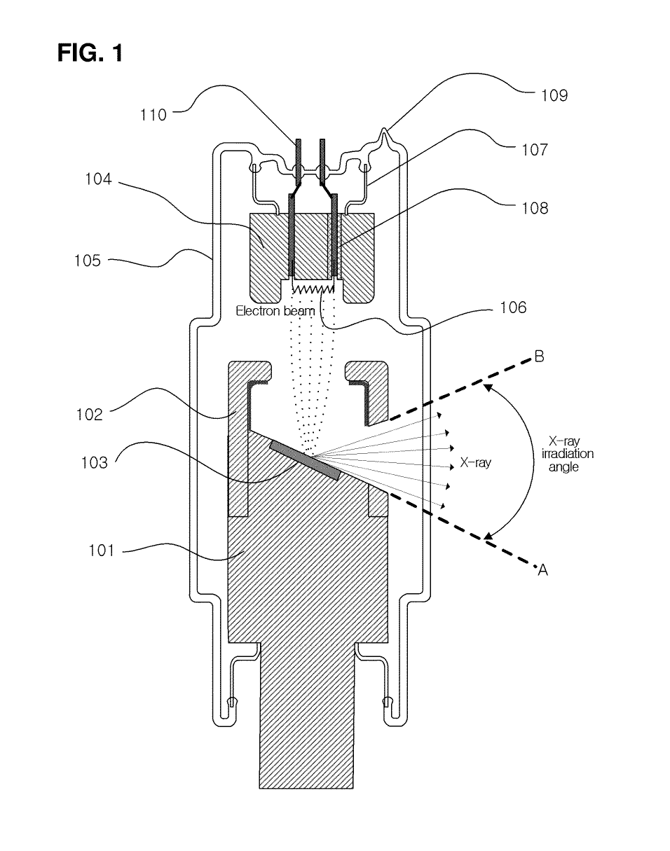

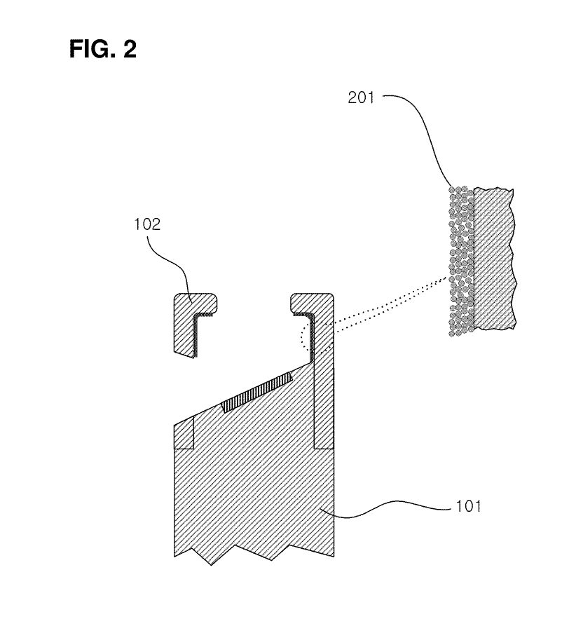

FIG. 1 shows the basic structure of a shielded fixed-anode X-ray tube according the first embodiment of the invention. FIG. 2 shows non-evaporable getters disposed in an inner surface of an anode shielding unit. With reference to FIGS. 1 and 2, a fixed-anode X-ray tube according to an embodiment includes a shielded anode (101), an anode shielding unit (102), a target (103), a cathode focusing cap (104), an outer bulb (pyrex bulb) (105), a cathode filament (106), and non-evaporable getters (201) sintered and disposed in a predetermined height. The reference numbers 110, 109, 108, and 107, respectively, refer to an electrode stem, a sealing unit for sealing a vacuum discharge tube, an insulating tube for insulating the electrode stem, and a kovar adapter for fixing the cathode focusing cap (104) to the pyrex bulb (105), details of which are omitted. In the X-ray tube according to the embodiment in which the target (103) is shielded by the anode shielding unit (102), the non-evaporable getters (201) are disposed on an inner surface of the anode shielding unit (102).

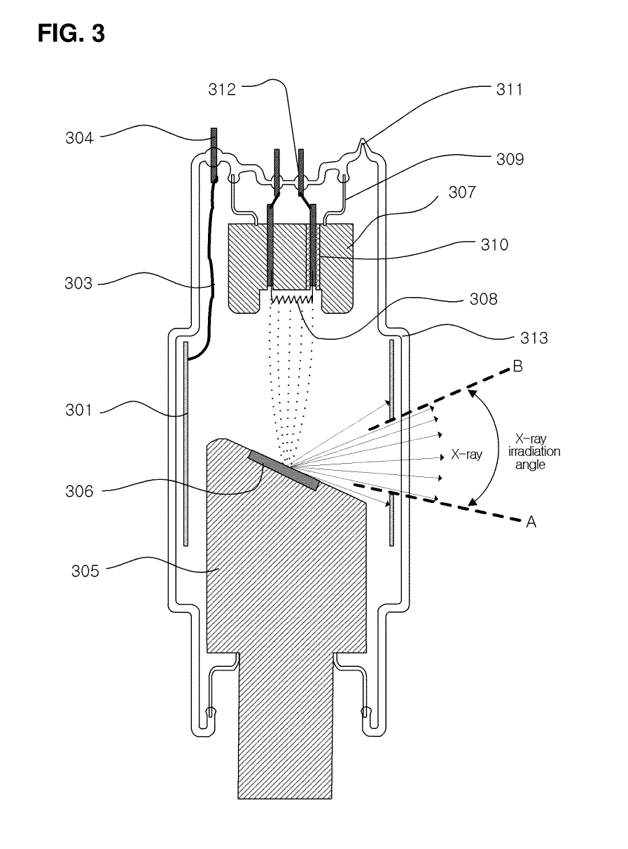

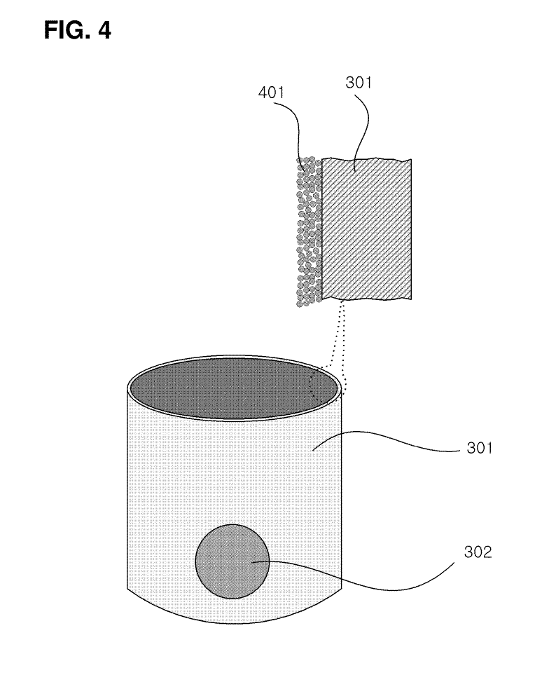

FIG. 3 shows the basic structure of an exposed fixed-anode X-ray tube according the second embodiment of the invention, the structure of a metal cylinder in which non-evaporable getters are disposed, and the structure of an electrode stem for grounding. FIG. 4 shows the non-evaporable getters disposed on an inner surface of the metal cylinder. With reference to FIGS. 3 and 4, the exposed fixed-anode X-ray tube according to the second embodiment includes a metal cylinder (301) in which non-evaporable getters are disposed, a grounding electrical line (303), an electrode stem for grounding (304), an exposed anode (305), a target (306), a cathode focusing cap (307), a cathode filament (308), a pyrex bulb (outer bulb) (313), and non-evaporable getters (401) sintered and coated on the metal cylinder (301) in a predetermined height. The metal cylinder (301) has at least one radiation window (302) through which X-rays are radiated. The radiation window (302) may be formed as a hole to allow X-rays to be radiated. The reference numbers 309, 310, and 311, respectively, refer to a kovar adapter for fixing the cathode focusing cap (307) to the pyrex bulb (313), an insulating tube (310) for insulating a part of the electrode stem (312) to be inserted in the cathode focusing cap (307), and a sealing unit for vacuum discharge, details of which are omitted. In the X-ray tube according to the embodiment in which the target (103) is exposed, the non-evaporable getters (401) are disposed on an inner surface of the metal cylinder (301) positioned at a location neighboring the target.

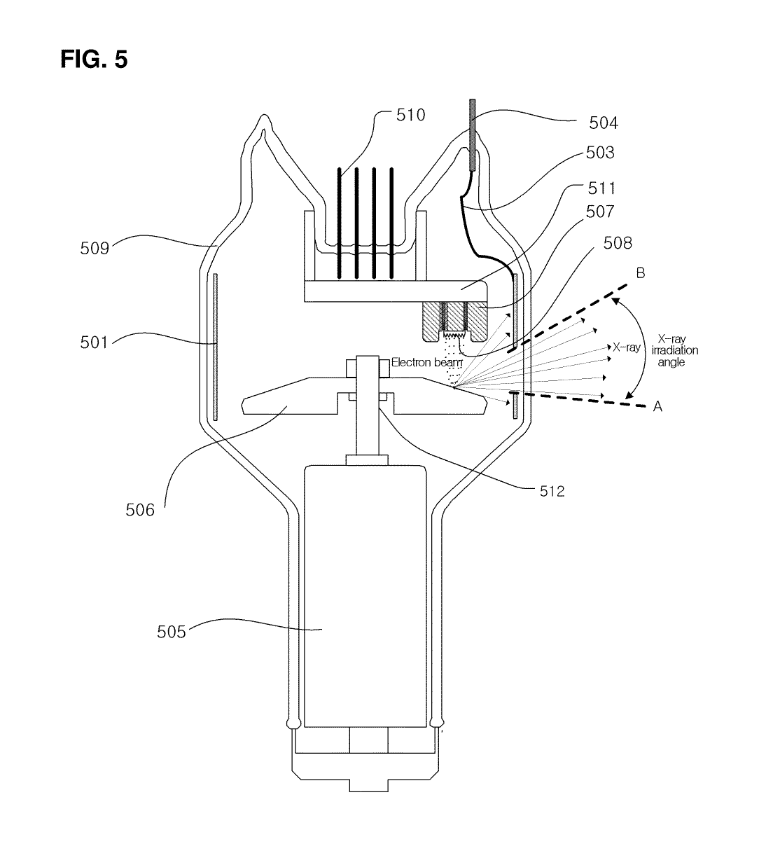

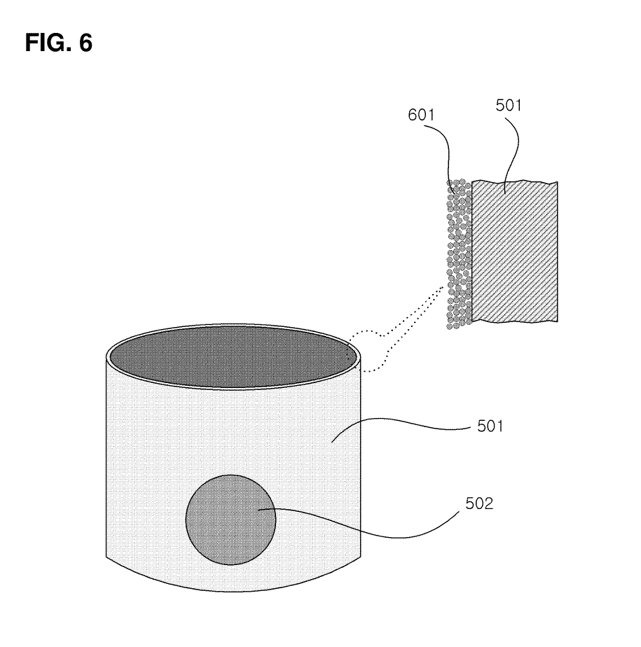

FIG. 5 shows the basic structure of a rotating-anode X-ray tube according a third embodiment of the invention, the structure of a metal cylinder in which non-evaporable getters are disposed, and the structure of an electrode stem for grounding. FIG. 6 shows the non-evaporable getters disposed in an inner surface of the metal cylinder. With reference to FIGS. 5 and 6, the rotating-anode X-ray tube according to the third embodiment includes a metal cylinder (501) in which non-evaporable getters are disposed, a radiation window (502) provided in the metal cylinder, through which X-rays are radiated, an electrode stem for grounding (503), a grounding electrical line (504), a rotating-anode rotor (505), a rotating-anode target (506), a cathode focusing cap (507), a cathode filament (508), a pyrex bulb (outer bulb) (509), and non-evaporable getters (601) sintered and coated on the metal cylinder (301) in a predetermined height. In this embodiment, the non-evaporable getters are disposed on an inner surface of the metal cylinder (501).

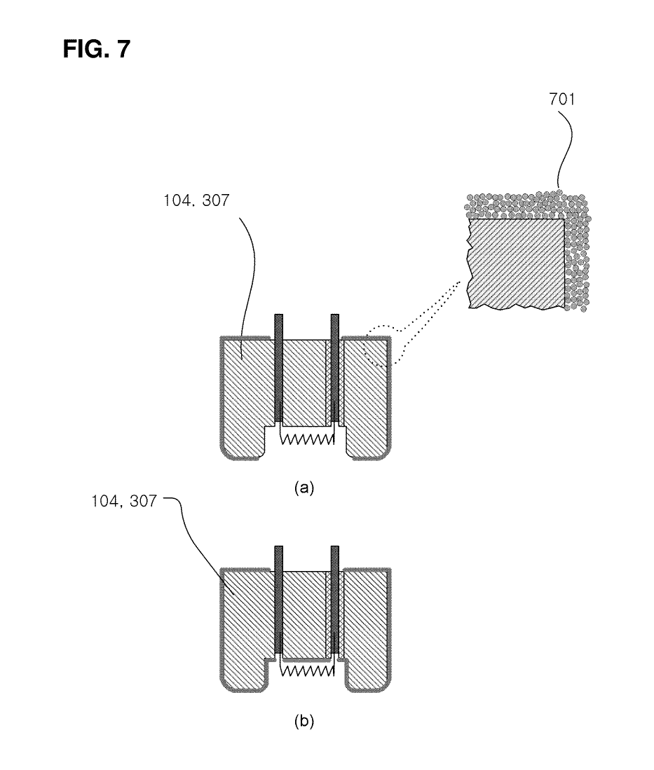

As shown in FIG. 7(a), according to the fourth embodiment of the invention, in a shielded fixed-anode X-ray tube, non-evaporable getters (701) are disposed on an outer circumferential surface of the cathode focusing cap (104) except for the area around the filament, and according to the fifth embodiment, in an exposed fixed-anode X-ray tube, non-evaporable getters (701) are disposed on an outer circumferential surface of the cathode focusing cap (104) except for the area around the filament. As shown in FIG. 7(b), according to the sixth and seventh embodiments, in a shielded fixed-anode X-ray tube and an exposed fixed-anode X-ray tube, respectively, non-evaporable getters are disposed on an outer circumferential area of the cathode focusing cap (104) including the area around the filament.

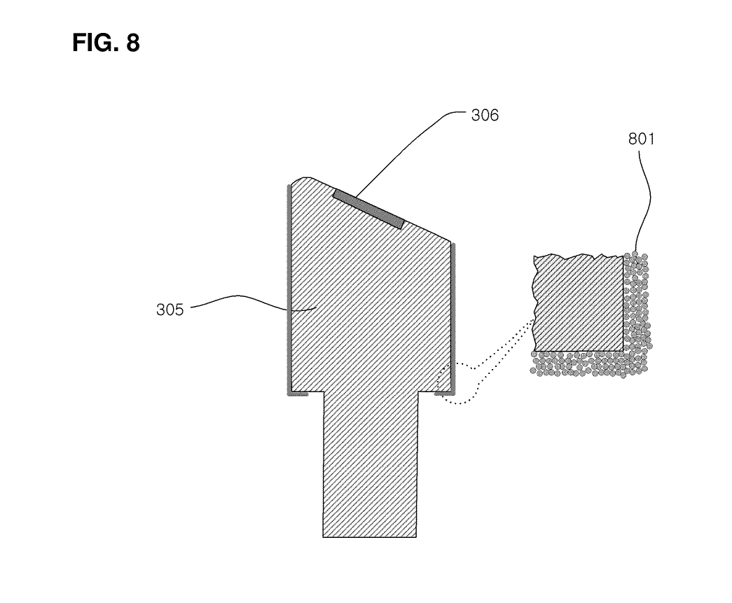

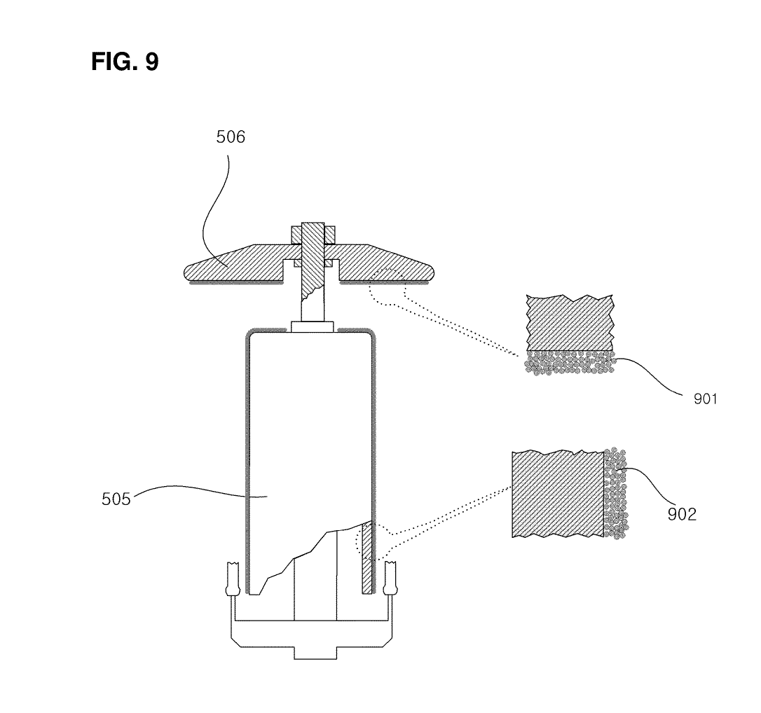

As shown in FIG. 8, according to the eighth embodiment, in a fixed-anode X-ray tube, non-evaporable getters (801) are disposed on an outer circumferential surface of the anode (305) except for area around the target (306). As shown in FIG. 9, according to the ninth embodiment, non-evaporable getters (901) are disposed on a back surface of a rotating-anode (506), and according to the tenth embodiment, non-evaporable getters are disposed on an outer circumferential surface of a rotor (505).

Hereinbelow, the functions of the elements of the X-ray tubes are described.

The cathode focusing cap (104, 307) of a shielded or exposed fixed-anode X-ray tube (100, 300) functions to not only support a filament supporter and a filament (106, 308) but also focus electron beams, which is produced by accelerating thermo electrons generated when the filament is heated, to the target in a predetermined size (i.e., diameter). The target (103, 306) functions to generate X-rays when it is collided by the accelerated electron beam. The anode (101, 305) functions to support the target (103, 306), absorb and save heat generated at the target (103, 306) and emit it to an external side, and act as an electrode to which a high voltage is introduced. The filament (106, 308), which is supported by a support electrode to which power for the filament and the high-voltage power are introduced, functions to emit thermo electrons by being heated by the power introduced by the support electrode.

The pyrex bulb (105, 313) functions to not only support the cathode unit (including the cathode focusing cap (104, 307) and the anode filament (106, 308)) and the anode unit (101, 305) while they are insulated but also provide sealing effect to maintain the inner vacuum state.

The anode unit of a rotating-anode X-ray tube (500) includes a rotating-anode target (506) in the form of a disk, a rotor (505) supporting the target, and a rotating axis (512). The target (506) is rotated to cause the electron beam collision region to be in the form of a circular track, thereby making it possible to produce high output X-rays.

The grounding electric line (303) and the electrode stem for grounding (304) of an exposed fixed-anode X-ray tube and the grounding electric line (503) and the electrode stem for grounding (504) of a rotating-anode X-ray tube function to discharge a static charge generated in the metal cylinder in which non-evaporable getters are disposed.

Gases existing inside an X-ray tube can be discharged before sealing the X-ray tube by a certain vacuum system. The function and performance of an X-ray tube can vary depending on the degree of vacuum during operation.

Problems associated with operation of an X-ray tube and a solution to solve the problems are described below.

When a filament is heated, thermo electrons are emitted. A tube current is formed by acceleration due to a high difference between the anode to which a certain voltage is introduced and the cathode focusing cap. The tube current electron beam focused by the cathode focusing cap is collided with the target, thereby generating X-rays. The X-rays emit forwardly at the highest strength by the target tilted at a certain angle (i.e., a radiation angle between A and B of FIGS. 1, 3, and 5).

In prior art X-ray tubes, as described above, gases (or particles, ions, and the like) can be generated from a cathode filament when the filament is heated in order to generate thermo electrons. Gases can also be generated from a target when accelerated electron beam collides with the target. These gases can cause the inner gas pressure of the X-ray tubes to be increased, which in turn can reduce the overall performance of the X-ray tubes or lose the function.

According to the present invention, however, during operation, the gas adsorption rate of non-evaporable getters (201, 401, 601) is sharply increased by X-rays generated when high voltage power is introduced between the cathode focusing cap and the anode. Accordingly, the function of the X-ray tube according to the present invention can be maintained stably even if some gases are generated during operation as described above.

For this purpose, in a shielded fixed-anode X-ray tube (FIG. 1), non-evaporable getters (201) are disposed on an inner surface of the anode shielding unit (102) of the shielded fixed-anode X-ray tube. In some embodiments, the non-evaporable getters (201) are provided as a porous structure in the form of a band or cylinder, which is formed by disposing a gettering material on one or both surfaces of a metal plate. This structure can then be mounted into an inner wall surface of a cylindrical anode shielding unit (102), to which the invention is not limited, however. The cylindrical anode shielding unit (102) has a hole at the center thereof. Within the cylindrical anode shielding unit and below the hole, the target (103) is positioned at an upper surface of the anode (101) such that electron beam that passed the hole can collide with the target.

In other embodiments, such a gettering material is disposed on an inner wall surface of the cylindrical anode shielding unit (102) by spraying or printing methods.

In an exposed fixed-anode X-ray tube (FIG. 3) and a rotating-anode X-ray tube (FIG. 5), non-evaporable getters (401, 601) are disposed in a metal cylinder (301, 501). In some embodiments, the non-evaporable getters (401) are disposed at a porous structure on one or both surfaces of the metal cylinder by, e.g., spraying methods, and/or printing methods, and/or sintering methods, and/or vacuum deposition methods. In other embodiments, as described above, a porous structure in the form of a band or cylinder is provided using gettering materials and the (gettering) structure is then mounted to the metal cylinder (301, 501) at a desired position.

Preferably, the non-evaporable getters (201, 401, 601, 701, 801, 901) may be formed by disposing a powder of a metal, an alloy, or a porous metal compound on a desired substrate. Examplary material thereof include a single metal such as Zr, Ni, Ti, Ba, or the like, and an alloy such as Zr—Al, Zr—V—Fe, or the like. This can be coated as a single layer or multiple layers. This can be formed as a band or cylinder.

### Example 1

X-ray tubes attached to a vacuum discharge system were tested to compare the degree of vacuum obtained when non-evaporable getters are disposed and the one when they are not disposed.

A vacuum discharge system in which a cryo pump is used as a main pump was attached to a first exposed fixed-anode X-ray tube in which non-evaporable getters are disposed. A vacuum discharge system in which a cryo pump is used as a main pump was attached to a second exposed fixed-anode X-ray tube in which non-evaporable getters are not disposed. The base degree of vacuum of the two X-ray tubes was maintained at 5×10⁻⁹ Torr. The vacuum discharging speed of the two X-ray tubes was maintained at a certain level. While vacuum discharging is performed, electric power was introduced to the cathode filament (308) and a high tube voltage was introduced between the cathode focusing cap (307) and the anode (305). The high tube voltage was at 90 kV (+45 kV, −45 kV).

Table 1 shows the change in the degree of vacuum of the second X-ray tube with the tube current of 30 mA, the tube voltage of 90 kV (+45 kV, −45 kV), the introduction time of 20 seconds, and the initial anode temperature of 21° C. Table 2 shows the change in the degree of vacuum of the first X-ray tube with the tube current of 30 mA, the tube voltage of 90 kV(+45 kV, −45 kV), the introduction time of 30 seconds, and the initial anode temperature of 21° C. Although the change in the degree of vacuum can vary depending on performance of a vacuum discharge system, cleanness of parts and materials of an X-ray tube, the inner volume of the X-ray tube, and the like, the data shown in Tables 1 and 2 can be used to compare the first and second X-ray tubes.

TABLE 1

| Time | Degree of Vacuum |
|---|---|
| Before power introduction | 5 × 10⁻⁹ Torr |
| Right after introduction | 7 × 10⁻⁷ Torr |
| 5 seconds after introduction | 2 × 10⁻⁶ Torr |
| 10 seconds after introduction | 5 × 10⁻⁶ Torr |
| 15 seconds after introduction | 7 × 10⁻⁶ Torr |
| 20 seconds after introduction | 9 × 10⁻⁶ Torr |

TABLE 2

| Time | Degree of Vacuum |
|---|---|
| Before power introduction | 5 × 10⁻⁹ Torr |
| Right after introduction | 6 × 10⁻¹¹ Torr |
| 5 seconds after introduction | 5 × 10⁻¹¹ Torr |
| 10 seconds after introduction | 5 × 10⁻¹¹ Torr |
| 15 seconds after introduction | 4 × 10⁻¹¹ Torr |
| 20 seconds after introduction | 4 × 10⁻¹¹ Torr |

### Example 2

A first exposed fixed-anode X-ray tube in which non-evaporable getters are disposed and a second exposed fixed-anode X-ray tube in which non-evaporable getters are not disposed were prepared. The first and second X-ray tubes were sealed after being subjected to vacuum process. The X-ray tubes were dipped into insulating oil. High voltage power was introduced. The resulting tube current wave was measured using an oscilloscope.

When power was introduced into the second X-ray tube, which was not subjected to an aging process, with the tube current of 20 mA, the tube voltage of 120 kV (+60 kV, −60 kV) between the cathode focusing unit and the anode, the introduction time of 2 seconds, and the temperature of the insulting oil of 20° C., it was observed that the tube current wave was unstable and failure of related power devices occurred.

On the other hand, when power was introduced into the first X-ray tube, which was not subjected to an aging process, with the tube current of 20 mA, the tube voltage of 120 kV (+60 kV, −60 kV) between the cathode focusing unit and the anode, the introduction time of 2 seconds, and the temperature of the insulting oil of 20° C., it was observed that the tube current wave was stable without devices failure.

The testing condition (20 mA, 120 kV (+60 kV, −60 kV), 2 seconds) in not related to maximum introduction curve data; it is the condition to compare the first and second X-ray tubes.

As shown in Examples 1 and 2, when non-evaporable getters are disposed in X-ray tubes (FIGS. 2, 4, and 5), the X-ray tubes show sufficient gas adsorption during operation when rated power is introduced into the X-ray tubes without an aging process. The sufficient gas adsorption can occur even if gases are generated by the cathode filament and cathode focusing cap and gases are generated by the target. As a result, X-ray tubes according to the present invention can be operated stably.

X-ray tubes according to the embodiments of the invention can maintain a high degree of vacuum stably during operation even when rated power is introduced without an aging process, thereby being industrially or medically applicable.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

1. An X-ray tube comprising:
an outer bulb;
a cathode focusing cap fixedly mounted inside the outer bulb and provided with a filament;
an anode an end of which is mounted inside the outer bulb and the other end of which is protruding from the outer bulb so as to be outside the outer bulb, the anode being provided with a target to which electron beam generated by the filament is to be collided; and
an anode shielding unit provided near the anode, the anode shielding unit being provided with a radiation window that can shield the target and irradiate X-rays generated by the target, wherein the anode shielding unit is provided with non-evaporable getters for gas adsorption.

2. The X-ray tube of claim 1, wherein the anode shielding unit is provided with non-evaporable getters for gas adsorption by providing a gettering structure in the form of a band or cylinder, the structure having gettering materials disposed on one or both sides thereof as a porous structure, and mounting the gettering structure to an inner circumferential surface or an outer circumferential surface of the anode shielding unit.

3. The X-ray tube of claim 1, wherein the anode shielding unit is provided with non-evaporable getters for gas adsorption by disposing gettering materials on an inner circumferential surface or an outer circumferential surface of the anode shielding unit.

4. An X-ray tube comprising:
an outer bulb;
a cathode focusing cap fixedly mounted inside the outer bulb and provided with a filament;
an anode an end of which is mounted inside the outer bulb and the other end of which is protruding from the outer bulb so as to be outside the outer bulb, the anode being provided with a target to which electron beam generated by the filament is to be collided; and
an anode shielding unit provided near the anode, the anode shielding unit being provided with a radiation window that can shield the target and irradiate X-rays generated by the target, wherein the cathode focusing cap is provided with non-evaporable getters for gas adsorption.

5. An X-ray tube comprising:
an outer bulb;
a cathode focusing cap fixedly mounted inside the outer bulb and provided with a filament; and
an anode an end of which is mounted inside the outer bulb and the other end of which is protruding from the outer bulb so as to be outside the outer bulb, the anode being provided with a target to which electron beam generated by the filament is to be collided, wherein the cathode focusing cap is provided with non-evaporable getters for gas adsorption.

6. An X-ray tube comprising:
an outer bulb;
an electrode stem unit fixedly mounted inside the outer bulb;
a cathode focusing cap fixedly mounted to the electrode stem unit and provided with a filament;
a rotating-anode target to which electron beam generated by the filament is to be collided; and
a rotor for rotating the rotating-anode target, wherein the cathode focusing cap is provided with non-evaporable getters for gas adsorption.

7. The X-ray tube of any of claims 4 to 6, wherein the cathode focusing cap is provided with non-evaporable getters for gas adsorption by providing a gettering structure corresponding to the outer shape of the cathode focusing cap, the structure having gettering materials disposed on one or both sides thereof as a porous structure, and mounting the gettering structure to an inner circumferential surface or an outer circumferential surface of the anode shielding unit.

8. The X-ray tube of any of claims 4 to 6, wherein the cathode focusing cap is provided with non-evaporable getters for gas adsorption by disposing gettering materials on an outer circumferential surface of the cathode focusing cap.

9. An X-ray tube comprising:
an outer bulb;
a cathode focusing cap fixedly mounted inside the outer bulb and provided with a filament;
an anode an end of which is mounted inside the outer bulb and the other end of which is protruding from the outer bulb so as to be outside the outer bulb, the anode being provided with a target to which electron beam generated by the filament is to be collided; and
a metal cylinder mounted inside the outer bulb to surround the anode, the metal cylinder being provided with a radiation window, wherein the metal cylinder is provided with non-evaporable getters for gas adsorption.

10. An X-ray tube comprising:
an outer bulb;
an electrode stem unit fixedly mounted inside the outer bulb;
a cathode focusing cap fixedly mounted to the electrode stem unit and provided with a filament;
a rotating-anode target to which electron beam generated by the filament is to be collided;
a rotor for rotating the rotating-anode target; and
a metal cylinder mounted inside the outer bulb to surround the rotating-anode target, the metal cylinder being provided with a radiation window, wherein the metal cylinder is provided with non-evaporable getters for gas adsorption.

11. The X-ray tube of claim 9 or 10, wherein the metal cylinder is provided with non-evaporable getters for gas adsorption by disposing gettering materials on an inner surface or an outer surface of the metal cylinder.

12. The X-ray tube of claim 9 or 10, wherein the metal cylinder is provided with non-evaporable getters for gas adsorption by providing a gettering structure in the form of a band or cylinder, the structure having gettering materials disposed on one or both sides thereof as a porous structure, and mounting the gettering structure to an inner circumferential surface or an outer circumferential surface of the metal cylinder.

13. An X-ray tube comprising:
an outer bulb;
a cathode focusing cap fixedly mounted inside the outer bulb and provided with a filament; and
an anode an end of which is mounted inside the outer bulb and the other end of which is protruding from the outer bulb so as to be outside the outer bulb, the anode being provided with a target to which electron beam generated by the filament is to be collided, wherein an outer circumferential surface of the anode inside the outer bulb is provided with non-evaporable getters for gas adsorption.

14. The X-ray tube of claim 13, wherein the outer circumferential surface of the anode inside the outer bulb is provided with non-evaporable getters for gas adsorption by disposing gettering materials on the outer circumferential surface of the anode.

15. The X-ray tube of claim 13, wherein the outer circumferential surface of the anode inside the outer bulb is provided with non-evaporable getters for gas adsorption by providing a gettering structure in the form of a band or cylinder, the structure having gettering materials disposed on one or both sides thereof as a porous structure, and mounting the gettering structure to the outer circumferential surface of the anode.

16. An X-ray tube comprising:
an outer bulb;
an electrode stem unit fixedly mounted inside the outer bulb;
a cathode focusing cap fixedly mounted to the electrode stem unit and provided with a filament;
a rotating-anode target to which electron beam generated by the filament is to be collided; and
a rotor for rotating the rotating-anode target, wherein the rotating-anode target is provided with non-evaporable getters for gas adsorption.

17. The X-ray tube of claim 16, wherein the rotating-anode target is provided with non-evaporable getters for gas adsorption by disposing gettering materials on a back surface of the rotating-anode target.

18. The X-ray tube of claim 16, wherein the rotating-anode target is provided with non-evaporable getters for gas adsorption by providing a gettering structure in the form of a circular plate, the structure having gettering materials disposed on one or both sides thereof as a porous structure, and mounting the gettering structure to a back surface of the rotating-anode target.

19. An X-ray tube comprising:
an outer bulb;
an electrode stem unit fixedly mounted inside the outer bulb;
a cathode focusing cap fixedly mounted to the electrode stem unit and provided with a filament;
a rotating-anode target to which electron beam generated by the filament is to be collided; and
a rotor for rotating the rotating-anode target, wherein the rotor is provided with non-evaporable getters for gas adsorption.

20. The X-ray tube of claim 19, wherein the rotor is provided with non-evaporable getters for gas adsorption by disposing gettering materials on an outer circumferential surface of the rotor.

21. The X-ray tube of claim 19, wherein the rotor is provided with non-evaporable getters for gas adsorption by providing a gettering structure in the form of a band or cylinder, the structure having gettering materials disposed on one or both sides thereof as a porous structure, and mounting the gettering structure to an outer circumferential surface of the rotor.
